(19) United States
(12) Patent Application Publication
(10) Pub. No.: US 2026/0239127 A1
(43) Pub. Date: Aug. 13, 2026

(54) UE-BASED TA UPDATE FOR A CANDIDATE CELL

(71) Applicant: QUALCOMM Incorporated, San Diego, CA (US)

(72) Inventors: Fang YUAN, Beijing (CN); Yan ZHOU, San Diego, CA (US)

(21) Appl. No.: 19/161,203

(22) PCT Filed: Apr. 6, 2023
(86) PCT No.: PCT/CN2023/086513

§ 371 Date: Aug. 29, 2025

(51) Int. Cl. H04W 36/00; H04B 17/318; H04L 5/00

(52) U.S. Cl. CPC H04W 36/0072; H04B 17/328; H04L 5/0044

(57) ABSTRACT

Apparatus, methods, and computer program products for wireless communication are provided. An example method may include transmitting, to a network entity, capability information indicative of a support for UE-based timing advance (TA) update between a serving cell associated with the network entity and a candidate cell associated with the network entity for layer 1 (L1) or layer 2 (L2) mobility. The example method may further include receiving, from the network entity, a configuration for the UE-based TA update. The example method may further include communicate, with the candidate cell, an uplink transmission or a downlink transmission based on a derived TA for the candidate cell based on a TA for the serving cell and a reception timing difference associated with the serving cell and the candidate cell.

### TECHNICAL FIELD

The present disclosure relates generally to communication systems, and more particularly, to wireless communication systems with user equipment (UE) based timing advance (TA) update for a candidate cell for layer 1 (L1) or layer 2 (L2) mobility.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory. Based at least in part on stored information that is stored in the memory, the at least one processor is configured to cause the apparatus to transmit, to a network entity, capability information indicative of a support for UE-based TA update between a serving cell associated with the network entity and a candidate cell associated with the network entity for L1 or L2 mobility. Based at least in part on stored information that is stored in the memory, the at least one processor is configured to cause the apparatus to receive, from the network entity, a configuration for the UE-based TA update. Based at least in part on stored information that is stored in the memory, the at least one processor is configured to cause the apparatus to communicate, with the candidate cell, an uplink transmission or a downlink transmission based on a derived TA for the candidate cell based on a TA for the serving cell and a reception timing difference associated with the serving cell and the candidate cell.

In another aspect of the disclosure, a method, a computer-readable medium, and an apparatus at a network entity are provided. The apparatus may include a memory and at least one processor coupled to the memory. Based at least in part on stored information that is stored in the memory, the at least one processor is configured to cause the apparatus to obtain capability information associated with a UE indicative of a support for UE-based TA update between a serving cell associated with the network entity and a candidate cell associated with the network entity for L1 or L2 mobility. Based at least in part on stored information that is stored in the memory, the at least one processor is configured to cause the apparatus to transmit, for the UE, a configuration for the UE-based TA update. Based at least in part on stored information that is stored in the memory, the at least one processor is configured to cause the apparatus to communicate, via the candidate cell, an uplink transmission or a downlink transmission based on a derived TA for the candidate cell based on a TA for the serving cell and a reception timing difference associated with the serving cell and the candidate cell.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example timing advance (TA).

FIG. 5A is a diagram illustrating example beam management.

FIG. 5B is a diagram illustrating example inter-cell beam management.

FIG. 6 is a diagram illustrating an example of movement of UE and associated switching of special cell (SpCell) based on a configured candidate SpCell set.

FIG. 7 is a diagram illustrating an example cell configuration.

FIG. 8 is a diagram illustrating example communications between a network entity and a UE.

FIG. 9 is a diagram illustrating example reference time and processing time associated with UE-based TA update.

FIG. 10A is a diagram illustrating example uplink and downlink timing for a base station.

FIG. 10B is a diagram illustrating example uplink and downlink timing for a UE.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

FIG. 16 is a diagram illustrating an example of a hardware implementation for an example network entity.

### DETAILED DESCRIPTION

UE-based TA update (which may may also be referred to as “UE-based TA measurement” or “UE-based TA acquisition”) where a UE may determine a TA based on Rx timing difference between current serving cell (which may also be referred to as “currently active serving cell”) and candidate cell and TA value for the current serving cell may be used in some wireless communication systems. A UE may indicate capability (e.g., support) for UE-based TA update in a capability information signalling to the network. For UEs that indicate support for UE-based TA updates, the network may configure (e.g., by transmitting a configuration for UE-based TA update) the UEs to perform such updates. In addition to UE-based TA updates, PDCCH order-based TA updates may also be used. A PDCCH order may include signalling for triggering a random-access procedure at a UE. Aspects provided herein enable providing timing instances for UE-based TA update, which may facilitate more efficient UE-based TA updates that may enable more efficient wireless communication processing.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

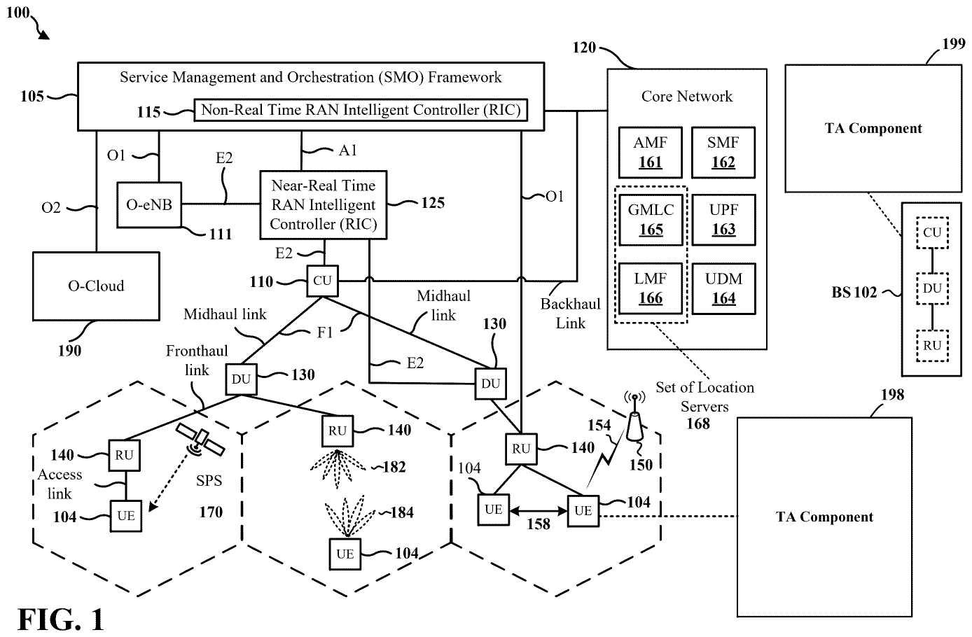

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a TA component 198. In some aspects, the TA component 198 may be configured to transmit, to a network entity, capability information indicative of a support for UE-based TA update between a serving cell associated with the network entity and a candidate cell associated with the network entity for L1 or L2 mobility. In some aspects, the TA component 198 may be further configured to receive, from the network entity, a configuration for the UE-based TA update. In some aspects, the TA component 198 may be further configured to communicate, with the candidate cell, an uplink transmission or a downlink transmission based on a derived TA for the candidate cell based on a TA for the serving cell and a reception timing difference associated with the serving cell and the candidate cell.

In certain aspects, the base station 102 may include a TA component 199. In some aspects, the TA component 199 may be configured to obtain capability information associated with a UE indicative of a support for UE-based TA update between a serving cell associated with the network entity and a candidate cell associated with the network entity for L1 or L2 mobility. In some aspects, the TA component 199 may be further configured to transmit, for the UE, a configuration for the UE-based TA update. In some aspects, the TA component 199 may be further configured to communicate, via the candidate cell, an uplink transmission or a downlink transmission based on a derived TA for the candidate cell based on a TA for the serving cell and a reception timing difference associated with the serving cell and the candidate cell.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

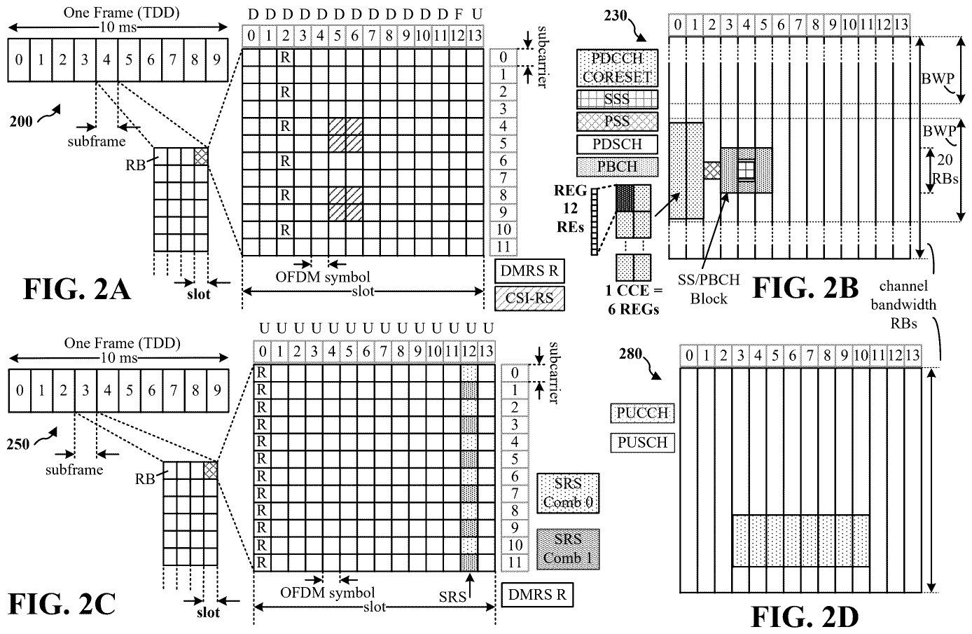

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

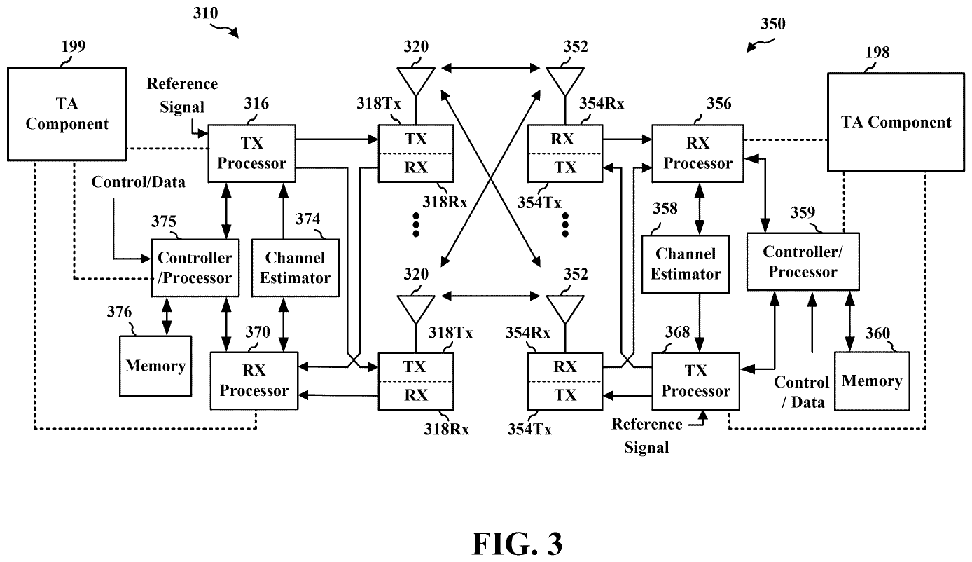

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality. The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with TA component 198 of FIG. 1.

At least one of the TX processor 316, the RX processor 370, and the controller/processor 375 may be configured to perform aspects in connection with TA component 199 of FIG. 1.

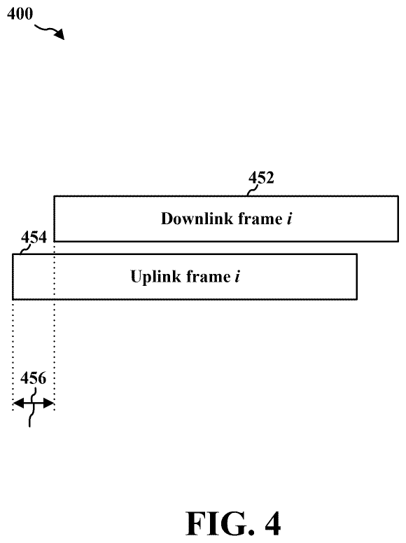

A UE may transmit an UL signal to a base station or a TRP. The UL signal may take a length of time to reach the destination base station or the TRP because the signal may travel from the UE to the destination base station or TRP for a length of time. Therefore, to meet a defined arrival time (e.g., defined based on slots or other units) in a wireless communication system, a UE in the wireless communication system may transmit UL signals based on a TA. As one example, the UE may transmit an UL signal a length of time before the defined arrival time based on a TA (e.g., to compensate the delay due to a distance between the UE and the TRP). FIG. 4 is a diagram 400 illustrating an example timing advance (TA). As illustrated in FIG. 4, a DL frame of frame number i 452 and an associated UL frame of frame number i 454 may be transmitted on a RF carrier. The UL frame of frame number i 454 may start in advance of the DL frame of frame number i 452 by a TA 456 that may be equal to (N_{TA}+N_{TA,offset}) T_{c}. The parameter T_{c} may represent a basic time unit, such as a one-bit period (e.g., approximately 3.69 microseconds). The parameter N_{TA,offset} may represent a TA defined based on a frequency band. The parameter N_{TA} may represent a TA that may be defined or signaled based on a location of the UE and the TRP or base station.

By way of example, in some wireless communication systems, the TA may be a value between 0 and 63, with each step between 0 and 63 representing an advance of one-bit period (e.g., approximately 3.69 microseconds). With signals (radio waves) travelling at about 300,000,000 meters per second (i.e., 300 meters per microsecond), one TA step then represents a change in round-trip distance (twice the propagation range) of approximately 1,100 meters. Therefore, in such an example, the TA may change for each 550-meter change in the distance between the UE and the TRP/base station.

A TAG may include one or more serving cells with a same uplink TA and a same downlink timing reference cell. Each TAG may be associated with at least one serving cell with configured uplink, and the mapping of each serving cell to a TAG may configured by radio resource control (RRC). As one example, a TAG may be associated with a PCell and one or more secondary cells. In such an example, the UE may use PCell as a timing reference. As another example, a TAG may be associated with one or more secondary cells and does not include a PCell. In such an example, the UE may use one of the activated SCells associated with the TAG as a timing reference.

A network may communicate with a UE based on one or more beams (spatial filters). For example, a base station of the network may transmit a beamformed signal to a UE in one or more directions that correspond with one or more beams. The base station and the UE may perform beam training to determine the best receive and transmit directions for the base station and the UE.

In response to different conditions, beams may be switched. For example, a transmission configuration indication (TCI) state change may be transmitted by a base station so that the UE may switch to a new beam for the TCI state. The TCI state change may cause the UE to find the best UE receive beam corresponding to the TCI state from the base station, and switch to such beam. Switching beams may allow for enhanced or improved connection between the UE and the base station by ensuring that the transmitter and receiver use the same configured set of beams for communication. A TCI state may include quasi co-location (QCL) information that the UE can use to derive timing/frequency error and/or transmission/reception spatial filtering for transmitting/receiving a signal.

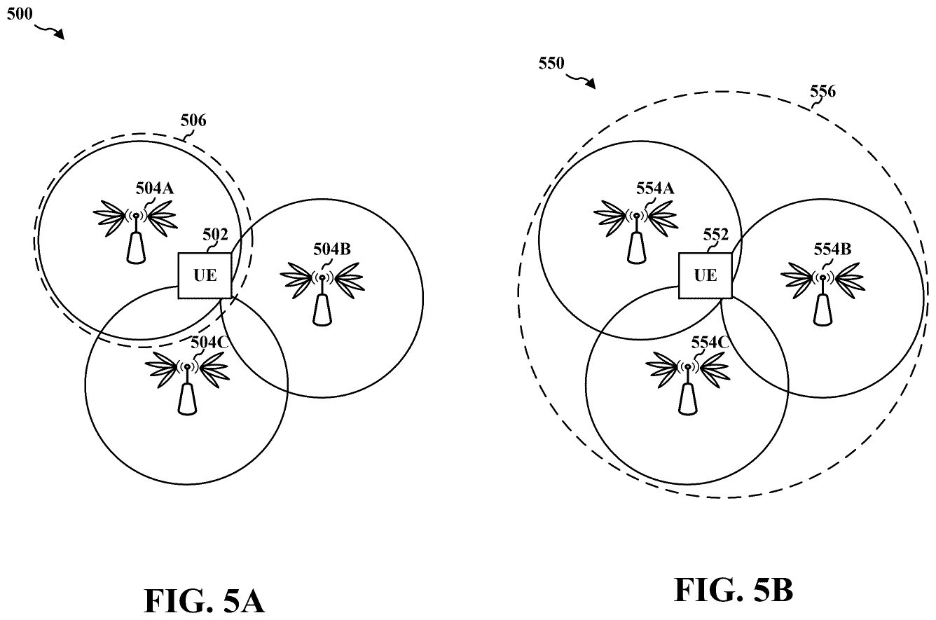

Different procedures for managing and controlling beams for wireless communication may be collectively referred to as “beam management.” The process of selecting a beam to switch to for data channels or control channels may be referred to as “beam selection.” In some wireless communication systems, beam selection for data channels or control channels may be used for beams within the same physical cell identifier (ID) (PCI). A PCI may be associated with a TRP. FIG. 5A is a diagram 500 illustrating example beam management. As illustrated in FIG. 5A, for a UE 502, beam selection 506 may be used for beams within the PCI 504A and beams associated with the PCI 504B and the PCI 504C may not be used. As an example, each of the PCI 504A, the PCI 504B, and the PCI 504C may be associated with a different TRP.

By way of example, a UE may encounter two types of mobility-cell-level mobility and beam-level mobility (which may be beam-based mobility). For cell-level mobility, a UE may experience an inter-base station handover. In some wireless communication systems, for beam-level mobility, as previously explained, switching of beams may occur within the same base station.

In some wireless communication systems, inter-cell beam management may be based on beam-based mobility where the indicated beam may be from a TRP with different PCI with regard to the serving cell. Benefits of inter-cell beam management based on beam-based mobility may include more robustness against blocking, more opportunities for higher rank for subscriber data management (SDM) across different cells, and in general more efficient communication between a UE and the network. FIG. 5B is a diagram 550 illustrating example inter-cell beam management. As illustrated in FIG. 5B, for a UE 552, beam selection 556 may be based on beams within the PCI 554A and beams associated with the PCI 554B and the PCI 554C. As an example, each of the PCI 554A, the PCI 554B, and the PCI 554C may be associated with a different TRP.

As an example, inter-cell beam management based on beam-based mobility may be facilitated by L1 and/or L2 signaling such as UE-dedicated channels/RSs which may be associated with a switch to a TRP with different PCI according to downlink control information (DCI) or medium access control (MAC) control element (MAC-CE) based unified TCI update. As used herein, such mobility may be referred to as L1/L2 mobility.

In some aspects, the network may configure a set of cells for L1/L2 mobility. The set of cells for L1/L2 mobility may be referred to as L1/L2 mobility configured cell set. A subset of the L1/L2 mobility configured cell set may be activated (e.g., with L1 or L2 control signaling) and may be referred to as an L1/L2 mobility activated cell set (which may also be referred to as an L1/L2 activated mobility cell set). The subset of cells in the L1/L2 mobility configured cell set that are not activated or that are indicated to be deactivated may be referred to as an L1/L2 mobility deactivated cell set or a deactivated L1/L2 mobility cell set. The L1/L2 mobility activated cell set may be a group of cells in the L1/L2 mobility configured cell set that are activated and may be readily used for data and control transfer. The L1/L2 mobility deactivated cell set (which may be an L1/L2 mobility candidate cell set) may be a group of cells in the configured set that are configured for the UE yet deactivated (e.g. not used for data/control transfer until activated) and may be activated by L1/L2 signaling. Once activated, a deactivated cell may be used for data and control transfer between a UE and a base station. The L1/L2 inter-cell mobility may reduce mobility latency. The configuration and maintenance of multiple candidate cells may allow for a quicker application of configurations for the candidate cells, and the activated set of cells may provide for dynamic switching among the candidate serving cells (e.g., including an SpCell and SCell) based on L1 or L2 signaling.

The procedures of L1/L2 based inter-cell mobility are applicable to many scenarios. These scenarios may include standalone CA and NR-DC cases with serving cell changing within one CG, intra-DU cases and intra-CU inter-DU cases (applicable for standalone and CA, with no new RAN interface expected), intra-frequency and inter-frequency cases, FR1 and FR2 cases. In these scenarios, the source and target cells may be synchronized or non-synchronized.

For mobility management of the activated cell set, L1/L2 signaling may be used to activate/deactivate cells in the L1/L2 mobility configured cell set and to select beams within the activated cells (of the activated cell set). As the UE moves, cells from the L1/L2 mobility configured cell set may be deactivated and activated by L1/L2 signaling based on signal quality (e.g., based on measurements), loading, or the like. Example measurements may include cell coverage measurements represented by Radio Signal Received Power (RSRP), and quality represented by Radio Signal Received Quality (RSRQ), or other measurements that the UE performs on signals from the base station. In some aspects, the measurements may be L1 measurements such as one or more of an RSRP, an RSRQ, a received signal strength indicator (RSSI), or a signal to noise and interference ratio (SINR) measurement of various signals, such as an SSB, a PSS, an SSS, a broadcast channel (BCH), a DM-RS, CSI-RS, or the like.

In some aspects, all cells in the L1/L2 mobility configured cell set may belong to the same DU and the cells may be on the same or different carrier frequencies. Cells in the L1/L2 mobility configured cell set may cover a mobility area.

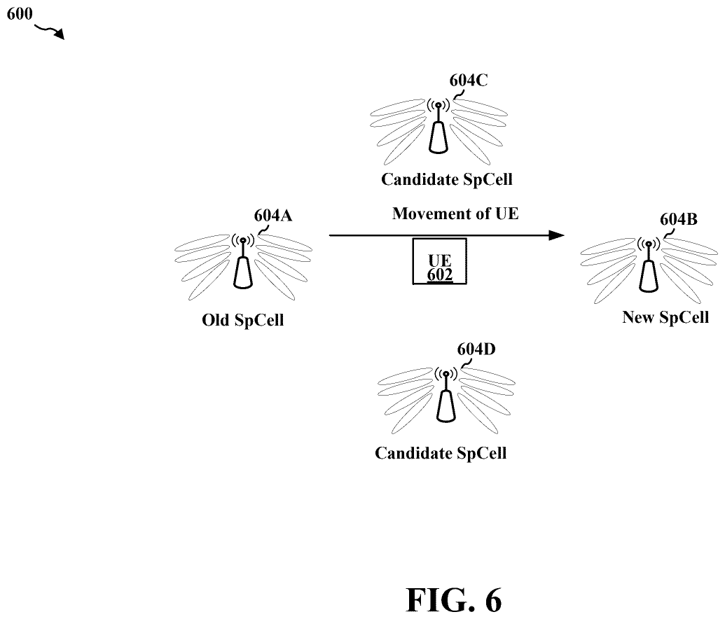

As a UE moves, the PCell may be reselected or updated among a set of configured candidate PCells based on the UE's measurements (e.g., L1 measurements such as reference signal received power (RSRP), reference signal received quality (RSRQ), received signal strength indicator (RSSI), or the like) for the candidate cells. FIG. 6 is a diagram 600 illustrating an example of movement of UE and associated switching of primary cell (PCell). As illustrated in FIG. 6, as a UE 602 moves, the UE 602 may update the PCell from old PCell 604A to one of the candidate PCells including candidate PCell 604B, candidate PCell 604C, and candidate PCell 604D. The candidate PCells may be activated (e.g., the UE may receive a TAG activation from the network) before being selected as a new PCell or may be deactivated before being selected as a new PCell. In some aspects, each of the candidate PCell 604B, the candidate PCell 604C, and the candidate PCell 604D may be associated with a different TAG. For example, the candidate PCell 604B may be associated with TAG 1, the candidate PCell 604C may be associated with TAG 2, and the candidate PCell 604C may be associated with TAG 3. In some aspects, the old PCell 604A may be configured with TAG 0. In some aspects, each of TAG 0, TAG 1, TAG 2, and TAG 3 may be previously configured for the UE 602 (e.g., before the UE moves). In some aspects, in case that a TAG is assigned to each deactivated candidate PCell, there may be other cells sharing the same TAG. For example, if the candidate PCell 604B is deactivated before being selected as a new PCell, there may be other cells sharing the TAG 1 with the candidate PCell 604B. For example, the other cells sharing the TAG 1 with the candidate PCell 604B may include candidate PCell and SCells in a candidate cell group associated with a physical cell site associated with the candidate PCell 604B. In some aspects, the candidate PCell and SCells in the candidate cell group associated with a physical cell site associated with the candidate PCell 604B may not be activated until the candidate PCell 604B is activated and selected as a new PCell. In some wireless communication systems, a UE may support up to four TAGs. In some aspects, a UE may support more than four TAGs.

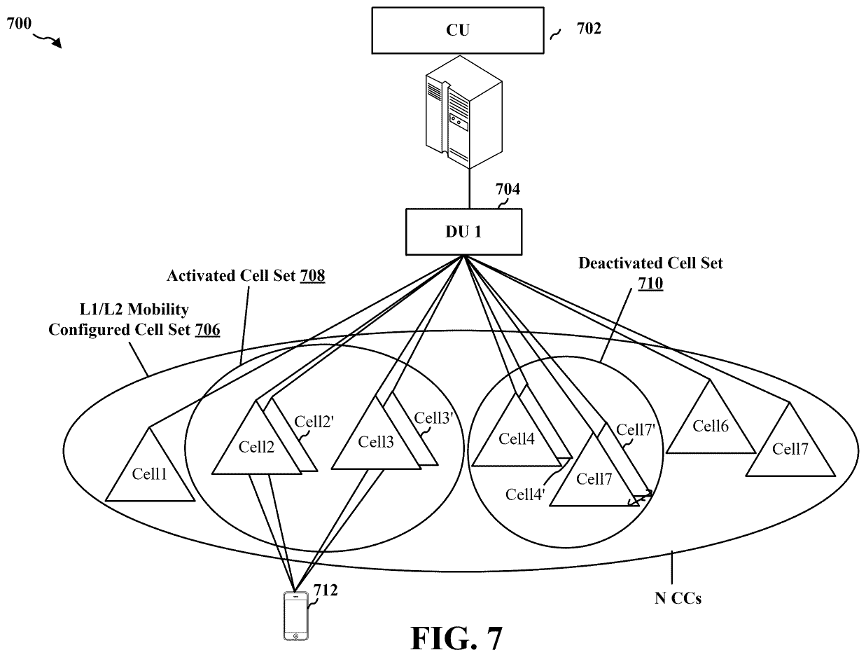

FIG. 7 is a diagram 700 illustrating an example cell configuration. As illustrated in FIG. 7, a CU 702 (which may correspond to a component of a base station such as a gNB) may be associated with a first DU 704 (and other DUs). An L1/L2 mobility configured cell set 706 may be associated with the first DU 704 and may include an L1/L2 mobility activated cell set 708 and an L1/L2 mobility deactivated cell set 710. The L1/L2 mobility configured cell set 706 may also include one or more cells not in the current L1/L2 mobility activated cell set 708 or the current L1/L2 mobility deactivated cell set 710. For example, at a given time, the L1/L2 mobility activated cell set 708 may include a first subset of cells in the L1/L2 mobility configured cell set, and the L1/L2 mobility deactivated cell set 710 may include a second, non-overlapping subset of cells in the L1/L2 mobility configured cell set. There may remain one or more cells that are in the L1/L2 mobility configured cell set that are not in the first set subset (e.g., activated) or the second subset (e.g., deactivated). A UE 712 may use the cells in the L1/L2 mobility activated cell set 708 for data channel and control channel communications.

A UE may be configured with a set of cells for L1/L2 mobility under the carrier aggregation (CA) framework. The set of the cells for L1/L2 mobility may be RRC configured and may include a single PCell and multiple SCells at a given time. The SCells may be updated as a PCell, e.g., changed to a PCell configuration or activated as a PCell, using L1/L2 signaling, and the PCell may be updated as, e.g., changed to, an SCell using L1/L2 signaling. For example, a cell may switch between acting as a PCell and an SCell for the UE.

A UE may be configured with a set of cells (C1, . . . , C6) for L1/L2 mobility. The set of cells, e.g., for L1/L2 inter-cell mobility, may be configured through RRC signaling. Cells in the configured set (including cells configured to act as a PCell and cells configured to act as SCells) may be further characterized into two groups: activated cells and deactivated cells. The activated cells may be serving cells that are currently active and can be used for data and control transfer between the network and the UE. The deactivated cells are cells that are currently deactivated (and hence have no active data or control communication with the UE) but can be quickly activated through L1/L2 signaling to the UE from the network. The UE may exchange, or monitor for, data and control communication with the base station on activated cells, and the UE may perform L1 measurement on all cells in the L1/L2 configured cell set (including both activated and deactivated cells).

In CA, the SCell may be activated by a MAC-CE. A PCell may be changed using L3 signaling. This disclosure presents a joint cell activation/deactivation message for SCell and PCell updates in L1/L2 mobility. The joint cell activation/deactivation facilitates fast and efficient L1/L2 mobility and potentially may include additional configuration selection for activated SCell and PCell. Additionally, the present disclosure further presents multiple options for joint MAC-CE and/or DCI design.

In some aspects of the present disclosure, cells in an L1/L2 mobility configured set may be controlled (e.g., activated and deactivated) by L1/L2 mobility signaling that conveys cell activation/deactivation and PCell activation/deactivation (in a single joint message). Joint L1/L2 signaling that contains an SCell activation/deactivation and PCell activation/deactivation command allows for simultaneous cell activation and designation as a PCell and simultaneous deactivation and PCell re-designation of a cell. If there is no PCell change and only SCell activation/deactivation is indicated, a MAC-CE for activation/deactivation of an SCell can be transmitted. As presented herein, the MAC-CE may include or an indication in the joint message indicating that there is no PCell change. The joint L1/L2 signaling may be implemented in a DCI format or a MAC-CE format. The DCI format or MAC-CE format may include a Logical Channel ID (LCID) or an eLCID for L1/L2 mobility cell activation/deactivation including SCell and PCell activation. The MAC-CE format or the DCI format may include one or more of: a pointer to the cell ID being activated/deactivated or setting the bit in the bitmap corresponding to the cell ID, a field indicating whether the cell is activated as the new PCell, a pointer to parameter spCellConfig (a PCell configuration) to be activated if multiple configurations are available for the cell or setting the bit in the bitmap corresponding to one of the available PCell configurations, TCI state(s) to be activated for each activated cell, an RS for beam refinement, and an RS ID to use for L1 reporting of the cells being deactivated (may be provided when cells are toggled or may be always provided). Cells that are not configured for L1/L2 mobility may be controlled by a CA activation/deactivation MAC-CE, e.g., rather than an L1/L2 mobility MAC-CE.

UE-based TA update (which may may also be referred to as “UE-based TA measurement” or “UE-based TA acquisition”) where a UE may determine a TA based on Rx timing difference between current serving cell (which may also be referred to as “currently active serving cell”) and candidate cell and TA value for the current serving cell may be used in some wireless communication systems. A UE may indicate capability (e.g., support) for UE-based TA update in a capability information signalling to the network. For UEs that indicate support for UE-based TA updates, the network may configure (e.g., by transmitting a configuration for UE-based TA update) the UEs to perform such updates. In addition to UE-based TA updates, PDCCH order-based TA updates may also be used. A PDCCH order may include signalling for triggering a random-access procedure at a UE. Aspects provided herein enable providing timing instances for UE-based TA update, which may facilitate more efficient UE-based TA updates that may enable more efficient wireless communication processing.

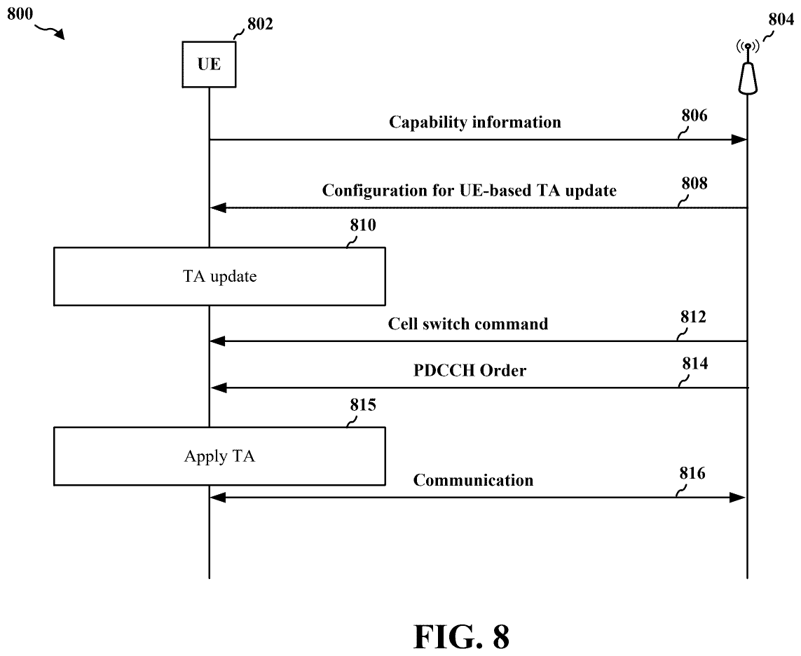

FIG. 8 is a diagram 800 illustrating example communications between a network entity 804 and a UE 802. The network entity 804 may be a network node. A network node may be implemented as an aggregated base station, a disaggregated base station, an integrated access and backhaul (IAB) node, a relay node, a sidelink node, or the like. A network entity can be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC. In some aspects, as illustrated in FIG. 8, the UE 802 may transmit capability information 806 indicative of support of UE-based TA update. As used herein, the term “capability information” may be information indicative of UE capability that may be carried in a signaling.

Based on the capability information 806 indicating support of UE-based TA update for the UE 802, the network entity 804 may transmit, for the UE 802, a configuration 808 for the UE-based TA update for a candidate cell. In some aspects, for UE-based TA update, the time instance for the UE 802 to update the TA may be determined based on instruction from the network entity 804 (e.g., in the configuration 808) or based on a configuration without signalling from the network entity 804. For example, the configuration 808 or the configuration without signalling from the network entity 804 may include periodicity, DL RS occasion, time, or other information indicative of time instance for the UE-based TA update. The UE 802 may perform the UE-based TA update at 810 based on the determined time instance. In some aspects, the UE 802 may perform the UE-based TA update for a candidate cell (e.g., a L1/L2 mobility candidate cell as described in connection with FIGS. 6-7) at 810 based on an environment change (which may be referred to “an occurrence of a condition). The term “environment change” may refer to a change associated with the UE that may trigger a update of the TA without signaling from the network. For example, an environment change may occur when the UE has not updated the TA for a time duration longer than a threshold. An environment change may also occur when RSRP, location, Doppler information, angle, or other location related or signaling related aspects changes by at least a configured threshold. In some aspects, the environment change may be configured by the network entity (e.g., in a configuration for the UE-based TA updated). In some aspects, the environment change may be configured without signaling from the network entity. Inputs related to the environment change may change compared to a last time of the UE-based TA update. For example, at least one of serving or candidate cell RS occasions to be measured, TA for serving cell, DL Tx timing difference between serving and candidate cell, or other parameters, may be changed.

In some aspects, for UE-based TA update, the network entity 804 may indicate (e.g., in the configuration 808) the periodic reference time instances at which the UE 802 may start updating the TA for candidate cell based on the latest measurement results. Such reference time instances may be represented by slot starting time. In some aspects, the minimum periodicity of reference time instances may be based on UE capability indicated in capability information 806. In some aspects, the processing time to determine the TA after each reference time instance may be based on UE capability indicated in capability information 806.

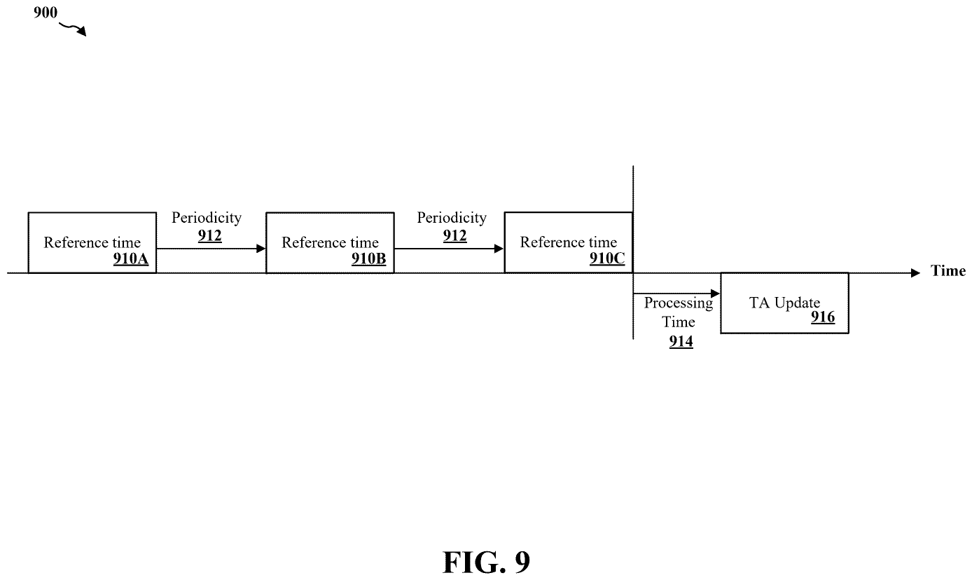

FIG. 9 is a diagram 900 illustrating example reference time and processing time associated with UE-based TA update. As illustrated in FIG. 9, there may be a first reference time 910A, a second reference time 910B, and a third reference time 910C. A periodicity of the reference time may be periodicity 912. The network entity may indicate the UE to update the TA starting from the third reference time 910C. After a processing time 914, the UE may update the TA at 916.

In some aspects, the network entity 804 may provide the UE 802 with information (e.g., in the configuration 808) for determining the TA for the candidate cell (e.g., at 810). In some aspects, the information provided may include cell ID, measured RS ID, and corresponding measured occasions for each of measured serving cell and candidate cell. In some aspects, the information provided may include difference between UL Rx timing and DL Tx timing at the serving cell (which may be the serving cell TA). In some aspects, the information provided may include DL Tx timing difference between the two measured RS IDs (dT).

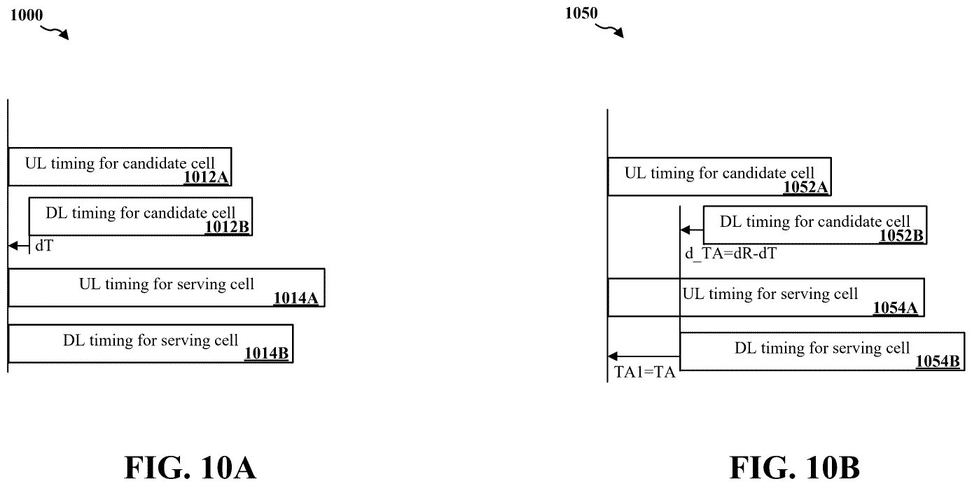

FIG. 10A is a diagram 1000 illustrating example uplink and downlink timing for a base station. As illustrated in FIG. 10A, there may be an UL timing for candidate cell 1012A and a DL timing for candidate cell 1012B which may start later than the UL timing for candidate cell 1012A by dT. There may be an UL timing for serving cell 1014A and DL timing for serving cell 1014B.

FIG. 10B is a diagram 1050 illustrating example uplink and downlink timing for a UE. As illustrated in FIG. 10A, there may be an UL timing for candidate cell 1052A and a DL timing for candidate cell 1052B which may start later than the UL timing for candidate cell 1052A by d_TA, which may be determined based on dT and dR (reference TA). There may be an UL timing for serving cell 1054A and DL timing for serving cell 1054B, which may start later than the UL timing for serving cell 1054A by TA1, which may be equal to an indicated TA for the serving cell.

Referring back to FIG. 8, in some aspects, the network entity 804 may transmit a cell switch command 812 to the UE 802 so that the UE 802 may switch to the candidate cell to communicate with the network entity 804 (e.g., communication 816). In some aspects, for UE-based TA acquisition, after receiving cell switch command, at 815, the UE 802 may apply the determined TA (e.g., determined at TA update 810) to the initial UL transmission on the new cell with the same TAG as the candidate cell associated with the determined TA. In some aspects, the UE 802 may receive a PDCCH order 814 from the network entity 804 (e.g., to facilitate a random access procedure associated with the new cell). In some aspects, the PDCCH order 814 may be associated with a PDCCH order-based TA update. In some aspects, either the TA based on PDCCH order-based TA update based on the PDCCH order 814 or the TA based on UE-based TA update at 810 may be used. In some aspects, both the TA based on PDCCH order-based TA update based on the PDCCH order 814 and the TA based on UE-based TA update at 810 may be used. For example, a latest acquired TA of the TA based on PDCCH order-based TA update based on the PDCCH order 814 and the TA based on UE-based TA update at 810 may be used. In some aspects, the cell switch command 812 may indicate (e.g., based on an explicit indicator) which TA among the TA based on PDCCH order-based TA update based on the PDCCH order 814 and the TA based on UE-based TA update at 810 may be used. In some aspects, the cell switch command 812 may implicitly indicate which TA among the TA based on PDCCH order-based TA update based on the PDCCH order 814 and the TA based on UE-based TA update at 810 may be used. For example, if the PDCCH order 814 is associated with a valid TA, the TA based on PDCCH order-based TA update based on the PDCCH order 814 may be used. If the PDCCH order 814 is not associated with a valid TA, the TA based on UE-based TA update at 810 may be used.

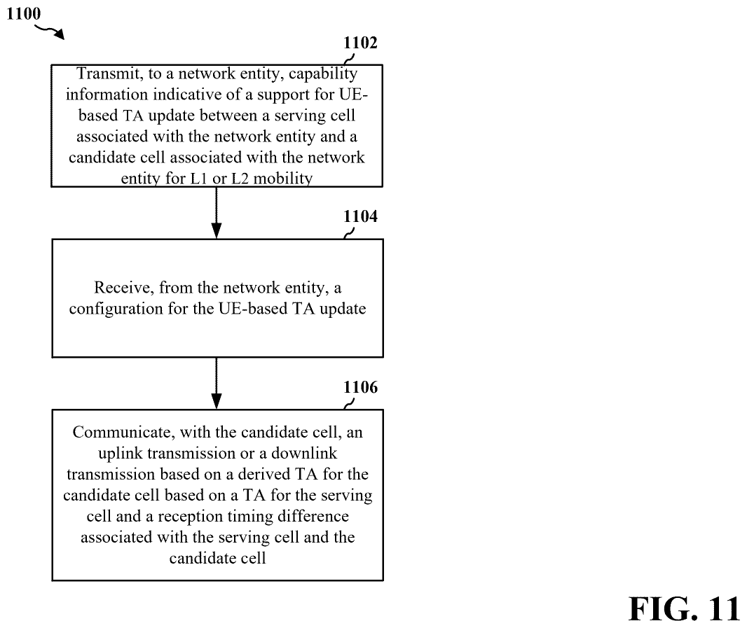

FIG. 11 is a flowchart 1100 of a method of wireless communication. The method may be performed by a UE (e.g., the UE 104, the UE 802; the apparatus 1504).

At 1102, the UE may transmit, to a network entity, capability information indicative of a support for UE-based TA update between a serving cell associated with the network entity and a candidate cell associated with the network entity for L1 or L2 mobility. For example, the UE 802 may transmit, to a network entity 804, capability information 806 indicative of a support for UE-based TA update between a serving cell associated with the network entity and a candidate cell associated with the network entity for L1 or L2 mobility. In some aspects, 1102 may be performed by TA component 198.

At 1104, the UE may receive, from the network entity 804, a configuration 808 for the UE-based TA update. For example, the UE 802 may receive, from the network entity, a configuration for the UE-based TA update. In some aspects, 1104 may be performed by TA component 198. In some aspects, the configuration is indicative of a time instance for the UE-based TA update, a DL RS associated with the time instance, or a periodicity associated with the time instance. In some aspects, the UE may receive, from the network entity (e.g., in the configuration), a reference time associated with the time instance. In some aspects, the reference time is represented by a slot starting time. In some aspects, the reference time is associated with the periodicity, and where the periodicity is based on the capability information. In some aspects, a time difference between the reference time and the time instance is based on the capability information. In some aspects, a time instance for the UE-based TA update is based on an occurrence of a condition associated with the UE, where the condition is based on at least one of: a difference between a current time and an last updated time associated with a previous derived TA, a RSRP, a location, Doppler information, or angle information. In some aspects, the UE may receive, from the network entity (e.g., in the configuration), a respective cell identifier, a respective measured reference signal ID, and a respective associated measured reference signal occasion associated with the serving cell and the candidate cell, and the TA. In some aspects, the UE may receive, from the network entity (e.g., in the configuration), information regarding time difference between a first measured reference signal ID associated with the serving cell and a second measured reference signal ID associated with the candidate cell for use in determining the derived TA.

At 1106, the UE may communicate, with the candidate cell, an uplink transmission or a downlink transmission based on a derived TA for the candidate cell based on a TA for the serving cell and a reception timing difference associated with the serving cell and the candidate cell. For example, the UE 802 may communicate, with the candidate cell, an uplink transmission or a downlink transmission (e.g., 816) based on a derived TA for the candidate cell based on a TA for the serving cell and a reception timing difference associated with the serving cell and the candidate cell. In some aspects, 1106 may be performed by TA component 198.

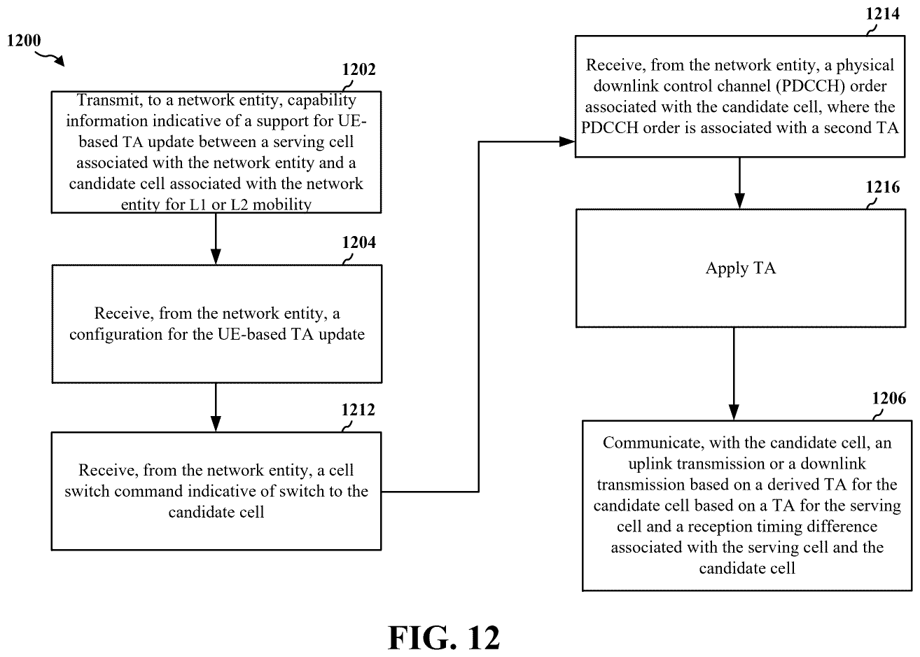

FIG. 12 is a flowchart 1200 of a method of wireless communication. The method may be performed by a UE (e.g., the UE 104, the UE 802; the apparatus 1504).

At 1202, the UE may transmit, to a network entity, capability information indicative of a support for UE-based TA update between a serving cell associated with the network entity and a candidate cell associated with the network entity for L1 or L2 mobility. For example, the UE 802 may transmit, to a network entity 804, capability information 806 indicative of a support for UE-based TA update between a serving cell associated with the network entity and a candidate cell associated with the network entity for L1 or L2 mobility. In some aspects, 1202 may be performed by TA component 198.

At 1204, the UE may receive, from the network entity 804, a configuration 808 for the UE-based TA update. For example, the UE 802 may receive, from the network entity, a configuration for the UE-based TA update. In some aspects, 1204 may be performed by TA component 198. In some aspects, the configuration is indicative of a time instance for the UE-based TA update, a DL RS associated with the time instance, or a periodicity associated with the time instance. In some aspects, the UE may receive, from the network entity (e.g., in the configuration), a reference time associated with the time instance. In some aspects, the reference time is represented by a slot starting time. In some aspects, the reference time is associated with the periodicity, and where the periodicity is based on the capability information. In some aspects, a time difference between the reference time and the time instance is based on the capability information. In some aspects, a time instance for the UE-based TA update is based on an occurrence of a condition associated with the UE, where the condition is based on at least one of: a difference between a current time and an last updated time associated with a previous derived TA, a RSRP, a location, Doppler information, or angle information. In some aspects, the UE may receive, from the network entity (e.g., in the configuration), a respective cell identifier, a respective measured reference signal ID, and a respective associated measured reference signal occasion associated with the serving cell and the candidate cell, and the TA. In some aspects, the UE may receive, from the network entity (e.g., in the configuration), information regarding time difference between a first measured reference signal ID associated with the serving cell and a second measured reference signal ID associated with the candidate cell for use in determining the derived TA.

At 1212, the UE may receive, from the network entity, a cell switch command indicative of switch to the candidate cell. For example, the UE 802 may receive, from the network entity, a cell switch command 812 indicative of switch to the candidate cell. In some aspects, 1212 may be performed by TA component 198.

At 1214, the UE may receive, from the network entity, a PDCCH order associated with the candidate cell, where the PDCCH order is associated with a second TA. For example, the UE 802 may receive, from the network entity, a PDCCH order 814 associated with the candidate cell, where the PDCCH order is associated with a second TA. In some aspects, 1214 may be performed by TA component 198.

At 1216, the UE may apply a TA. For example, the UE 802 may apply a TA at 810. In some aspects, 1216 may be performed by TA component 198. In some aspects, the UE may apply the derived TA or the second TA. In some aspects, the UE may apply a latest acquired TA of the derived TA or the second TA. In some aspects, the cell switch command indicates the derived TA or the second TA, and the UE may apply the derived TA or the second TA based on the cell switch command. In some aspects, the cell switch command indicates the derived TA or the second TA, and the UE may apply the second TA if the second TA is valid and apply the derived TA if there is no valid TA associated with the PDCCH order.

At 1206, the UE may communicate, with the candidate cell, an uplink transmission or a downlink transmission based on a derived TA for the candidate cell based on a TA for the serving cell and a reception timing difference associated with the serving cell and the candidate cell. For example, the UE 802 may communicate, with the candidate cell, an uplink transmission or a downlink transmission (e.g., 816) based on a derived TA for the candidate cell based on a TA for the serving cell and a reception timing difference associated with the serving cell and the candidate cell. In some aspects, 1206 may be performed by TA component 198.

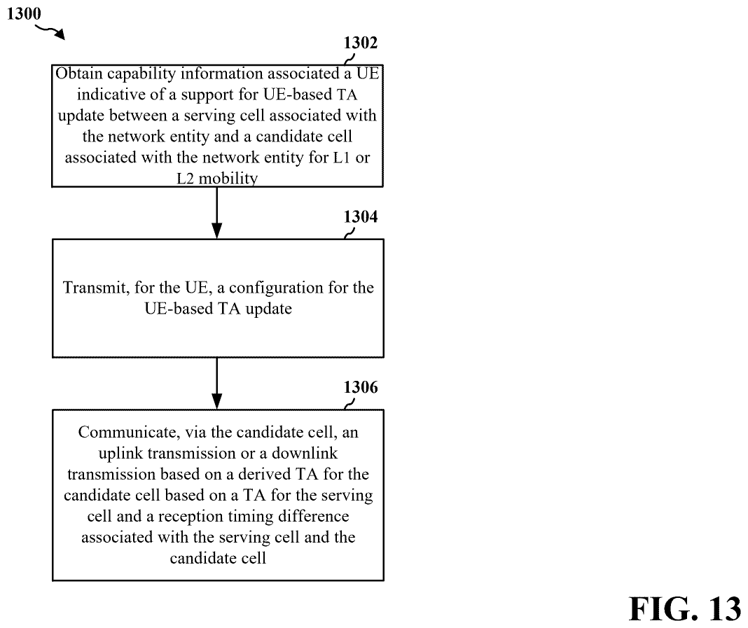

FIG. 13 is a flowchart 1300 of a method of wireless communication. The method may be performed by a network entity (e.g., the base station 102, the network entity 804, the network entity 1502, the network entity 1602).

At 1302, the network entity may obtain capability information associated a UE indicative of a support for UE-based TA update between a serving cell associated with the network entity and a candidate cell associated with the network entity for L1 or L2 mobility. For example, the network entity 804 may obtain capability information 806 associated a UE 802 indicative of a support for UE-based TA update between a serving cell associated with the network entity and a candidate cell associated with the network entity for L1 or L2 mobility. In some aspects, 1302 may be performed by TA component 199.

At 1304, the network entity may transmit, for the UE, a configuration for the UE-based TA update. For example, the network entity 804 may transmit, for the UE 802, a configuration 808 for the UE-based TA update. In some aspects, 1304 may be performed by TA component 199. In some aspects, the configuration is indicative of a time instance for the UE-based TA update, a DL RS associated with the time instance, or a periodicity associated with the time instance. In some aspects, the network entity may transmit, for the UE (e.g., in the configuration), a reference time associated with the time instance. In some aspects, the reference time is represented by a slot starting time. In some aspects, the reference time is associated with the periodicity, and where the periodicity is based on the capability information. In some aspects, a time difference between the reference time and the time instance is based on the capability information. In some aspects, a time instance for the UE-based TA update is based on an occurrence of a condition associated with the UE, where the condition is based on at least one of: a difference between a current time and an last updated time associated with a previous derived TA, a RSRP, a location, Doppler information, or angle information. In some aspects, the network entity may transmit, for the UE (e.g., in the configuration), a respective cell identifier, a respective measured reference signal ID, and a respective associated measured reference signal occasion associated with the serving cell and the candidate cell, and the TA. In some aspects, the network entity may transmit, for the UE (e.g., in the configuration), information regarding time difference between a first measured reference signal ID associated with the serving cell and a second measured reference signal ID associated with the candidate cell for use in determining the derived TA.

At 1306, the network entity may communicate, via the candidate cell, an uplink transmission or a downlink transmission based on a derived TA for the candidate cell based on a TA for the serving cell and a reception timing difference associated with the serving cell and the candidate cell. For example, the network entity 804 may communicate, via the candidate cell, an uplink transmission or a downlink transmission (e.g., 816) based on a derived TA for the candidate cell based on a TA for the serving cell and a reception timing difference associated with the serving cell and the candidate cell. In some aspects, 1306 may be performed by TA component 199.

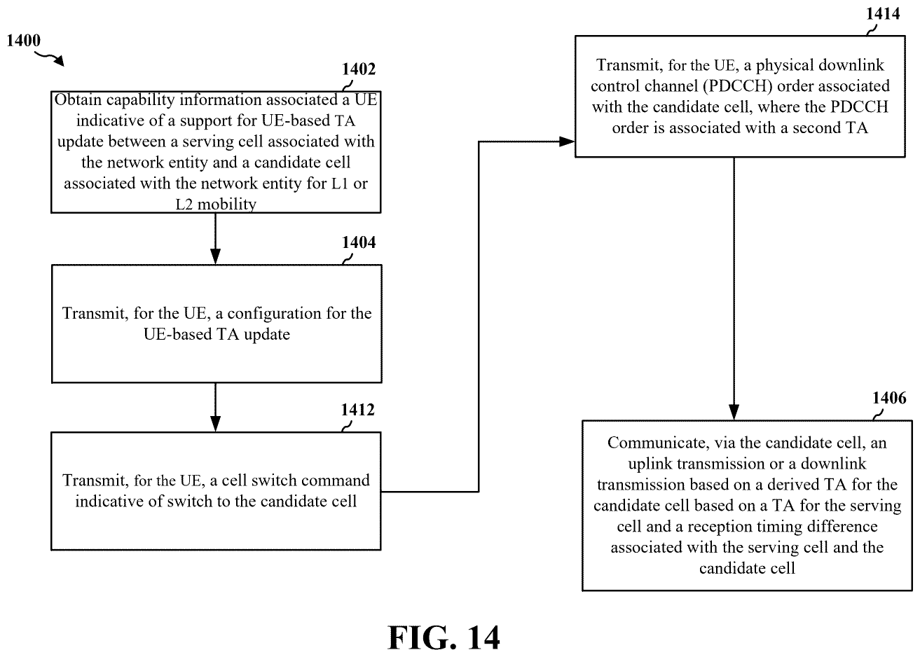

FIG. 14 is a flowchart 1400 of a method of wireless communication. The method may be performed by a network entity (e.g., the base station 102, the network entity 804, the network entity 1502, the network entity 1602).

At 1402, the network entity may obtain capability information associated a UE indicative of a support for UE-based TA update between a serving cell associated with the network entity and a candidate cell associated with the network entity for L1 or L2 mobility. For example, the network entity 804 may obtain capability information 806 associated a UE 802 indicative of a support for UE-based TA update between a serving cell associated with the network entity and a candidate cell associated with the network entity for L1 or L2 mobility. In some aspects, 1402 may be performed by TA component 199.

At 1404, the network entity may transmit, for the UE, a configuration for the UE-based TA update. For example, the network entity 804 may transmit, for the UE 802, a configuration 808 for the UE-based TA update. In some aspects, 1404 may be performed by TA component 199. In some aspects, the configuration is indicative of a time instance for the UE-based TA update, a DL RS associated with the time instance, or a periodicity associated with the time instance. In some aspects, the network entity may transmit, for the UE (e.g., in the configuration), a reference time associated with the time instance. In some aspects, the reference time is represented by a slot starting time. In some aspects, the reference time is associated with the periodicity, and where the periodicity is based on the capability information. In some aspects, a time difference between the reference time and the time instance is based on the capability information. In some aspects, a time instance for the UE-based TA update is based on an occurrence of a condition associated with the UE, where the condition is based on at least one of: a difference between a current time and an last updated time associated with a previous derived TA, a RSRP, a location, Doppler information, or angle information. In some aspects, the network entity may transmit, for the UE (e.g., in the configuration), a respective cell identifier, a respective measured reference signal ID, and a respective associated measured reference signal occasion associated with the serving cell and the candidate cell, and the TA. In some aspects, the network entity may transmit, for the UE (e.g., in the configuration), information regarding time difference between a first measured reference signal ID associated with the serving cell and a second measured reference signal ID associated with the candidate cell for use in determining the derived TA.

At 1412, the network entity may transmit, for the UE, a cell switch command indicative of switch to the candidate cell. For example, the network entity 804 may transmit, for the UE, a cell switch command 812 indicative of switch to the candidate cell. In some aspects, 1402 may be performed by TA component 199.

At 1414, the network entity may transmit, for the UE, a PDCCH order associated with the candidate cell, where the PDCCH order is associated with a second TA. For example, the network entity 804 may transmit, for the UE, a PDCCH order 814 associated with the candidate cell, where the PDCCH order is associated with a second TA. In some aspects, 1404 may be performed by TA component 199.

At 1406, the network entity may communicate, via the candidate cell, an uplink transmission or a downlink transmission based on a derived TA for the candidate cell based on a TA for the serving cell and a reception timing difference associated with the serving cell and the candidate cell. For example, the network entity 804 may communicate, via the candidate cell, an uplink transmission or a downlink transmission (e.g., 816) based on a derived TA for the candidate cell based on a TA for the serving cell and a reception timing difference associated with the serving cell and the candidate cell. In some aspects, 1406 may be performed by TA component 199.

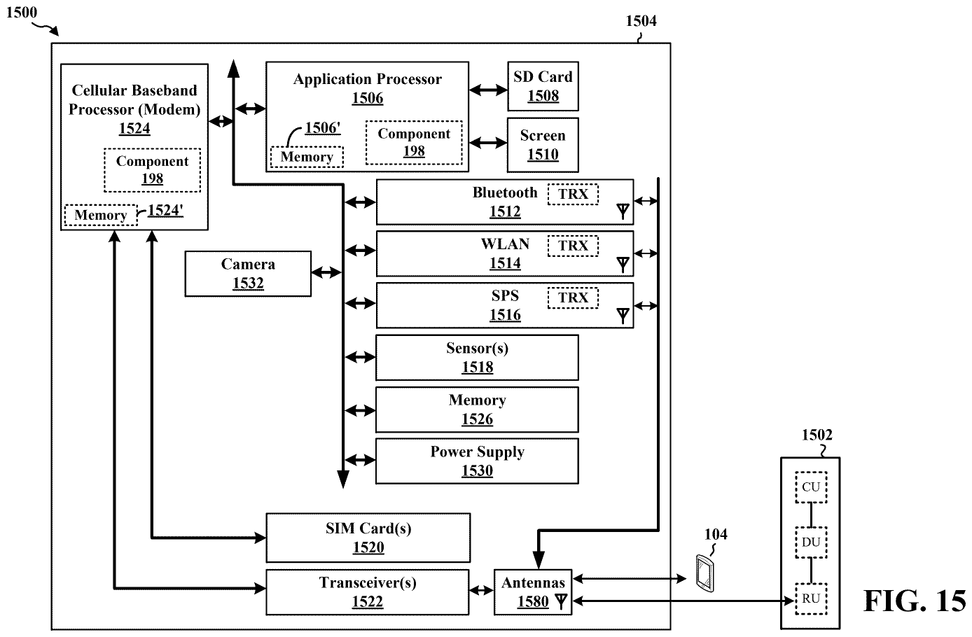

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include a cellular baseband processor 1524 (also referred to as a modem) coupled to one or more transceivers 1522 (e.g., cellular RF transceiver). The cellular baseband processor 1524 may include on-chip memory 1524′. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, a satellite system module 1516 (e.g., GNSS module), one or more sensor modules 1518 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the satellite system module 1516 may include an on-chip transceiver (TRX)/receiver (RX). The cellular baseband processor 1524 communicates through the transceiver(s) 1522 via one or more antennas 1580 with the UE 104 and/or with an RU associated with a network entity 1502. The cellular baseband processor 1524 and the application processor 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described herein. The computer-readable medium/memory may also be used for storing data that is manipulated by the cellular baseband processor 1524/application processor 1506 when executing software. The cellular baseband processor 1524/application processor 1506 may be a component of the UE 350 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., see 350 of FIG. 3) and include the additional modules of the apparatus 1504.

As discussed herein, the TA component 198 may be configured to transmit, to a network entity, capability information indicative of a support for UE-based TA update between a serving cell associated with the network entity and a candidate cell associated with the network entity for L1 or L2 mobility. In some aspects, the TA component 198 may be further configured to receive, from the network entity, a configuration for the UE-based TA update. In some aspects, the TA component 198 may be further configured to communicate, with the candidate cell, an uplink transmission or a downlink transmission based on a derived TA for the candidate cell based on a TA for the serving cell and a reception timing difference associated with the serving cell and the candidate cell. The TA component 198 may be within the cellular baseband processor 1524, the application processor 1506, or both the cellular baseband processor 1524 and the application processor 1506. The TA component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1504 may include a variety of components configured for various functions. In one configuration, the apparatus 1504, and in particular the cellular baseband processor 1524 and/or the application processor 1506, includes means for transmitting, to a network entity, capability information indicative of a support for UE-based TA update between a serving cell associated with the network entity and a candidate cell associated with the network entity for L1 or L2 mobility. In some aspects, the apparatus 1504 may further include means for receiving, from the network entity, a configuration for the UE-based TA update. In some aspects, the apparatus 1504 may further include means for communicating, with the candidate cell, an uplink transmission or a downlink transmission based on a derived TA for the candidate cell based on a TA for the serving cell and a reception timing difference associated with the serving cell and the candidate cell. In some aspects, the apparatus 1504 may further include means for receiving, from the network entity, a reference time associated with the time instance. In some aspects, the apparatus 1504 may further include means for receiving, from the network entity, a respective cell identifier, a respective measured reference signal ID, and a respective associated measured reference signal occasion associated with the serving cell and the candidate cell, and the TA. In some aspects, the apparatus 1504 may further include means for receiving, from the network entity, information regarding time difference between a first measured reference signal ID associated with the serving cell and a second measured reference signal ID associated with the candidate cell for use in determining the derived TA. In some aspects, the apparatus 1504 may further include means for receiving, from the network entity, a cell switch command indicative of switch to the candidate cell. In some aspects, the apparatus 1504 may further include means for receiving, from the network entity, a physical downlink control channel (PDCCH) order associated with the candidate cell, where the PDCCH order is associated with a second TA. In some aspects, the apparatus 1504 may further include means for applying the derived TA or the second TA. In some aspects, the apparatus 1504 may further include means for applying a latest acquired TA of the derived TA or the second TA. In some aspects, the apparatus 1504 may further include means for applying the derived TA or the second TA based on the cell switch command. In some aspects, the apparatus 1504 may further include means for applying the second TA if the second TA is valid and apply the derived TA if there is no valid TA associated with the PDCCH order. The means may be the TA component 198 of the apparatus 1504 configured to perform the functions recited by the means. As described herein, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

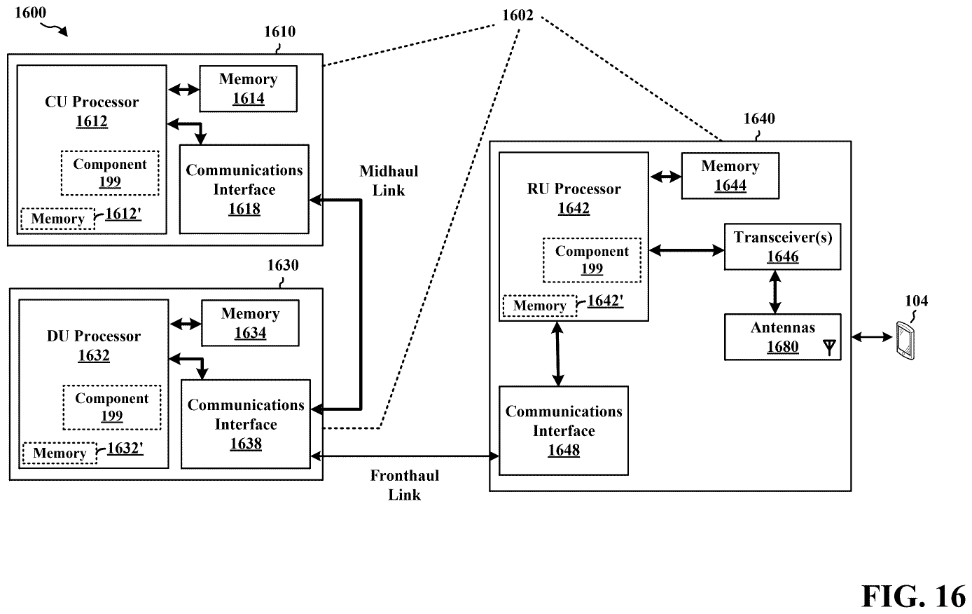

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include additional memory modules 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the TA component 199 may be configured to obtain capability information associated with a UE indicative of a support for UE-based TA update between a serving cell associated with the network entity and a candidate cell associated with the network entity for L1 or L2 mobility. In some aspects, the TA component 199 may be further configured to transmit, for the UE, a configuration for the UE-based TA update. In some aspects, the TA component 199 may be further configured to communicate, via the candidate cell, an uplink transmission or a downlink transmission based on a derived TA for the candidate cell based on a TA for the serving cell and a reception timing difference associated with the serving cell and the candidate cell. The TA component 199 may be within one or more processors of one or more of the CU 1610, DU 1630, and the RU 1640. The TA component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1602 may include a variety of components configured for various functions. In one configuration, the network entity 1602 includes means for obtaining capability information associated with a UE indicative of a support for UE-based TA update between a serving cell associated with the network entity and a candidate cell associated with the network entity for L1 or L2 mobility. In some aspects, the network entity 1602 may further include means for transmitting, for the UE, a configuration for the UE-based TA update. In some aspects, the network entity 1602 may further include means for communicating, via the candidate cell, an uplink transmission or a downlink transmission based on a derived TA for the candidate cell based on a TA for the serving cell and a reception timing difference associated with the serving cell and the candidate cell. In some aspects, the network entity 1602 may further include means for transmitting, for the UE, a reference time associated with the time instance.

In some aspects, the network entity 1602 may further include means for transmitting, for the UE, a respective cell identifier, a respective measured reference signal ID, and a respective associated measured reference signal occasion associated with the serving cell and the candidate cell, and the TA. In some aspects, the network entity 1602 may further include means for transmitting, for the UE, information regarding time difference between a first measured reference signal ID associated with the serving cell and a second measured reference signal ID associated with the candidate cell for use in determining the derived TA. In some aspects, the network entity 1602 may further include means for transmitting, for the UE, a cell switch command indicative of switch to the candidate cell. In some aspects, the network entity 1602 may further include means for transmitting, for the UE, a physical downlink control channel (PDCCH) order associated with the candidate cell, where the PDCCH order is associated with a second TA. The means may be the TA component 199 of the network entity 1602 configured to perform the functions recited by the means. As described herein, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method for wireless communication at a user equipment (UE), including: transmitting, to a network entity, capability information indicative of a support for UE-based TA update between a serving cell associated with the network entity and a candidate cell associated with the network entity for L1 or L2 mobility; receiving, from the network entity, a configuration for the UE-based TA update; and communicating, with the candidate cell, an uplink transmission or a downlink transmission based on a derived TA for the candidate cell based on a TA for the serving cell and a reception timing difference associated with the serving cell and the candidate cell.

Aspect 2 is the method of aspect 1, where the configuration is indicative of a time instance for the UE-based TA update, a DL RS associated with the time instance, or a periodicity associated with the time instance.

Aspect 3 is the method of aspect 2, further including: receiving, from the network entity, a reference time associated with the time instance.

Aspect 4 is the method of aspect 3, where the reference time is represented by a slot starting time.

Aspect 5 is the method of aspect 4, where the reference time is associated with the periodicity, and where the periodicity is based on the capability information.

Aspect 6 is the method of any of aspects 4-5, where a time difference between the reference time and the time instance is based on the capability information.

Aspect 7 is the method of any of aspects 1-6, where a time instance for the UE-based TA update is based on an occurrence of a condition associated with the UE, where the condition is based on at least one of: a difference between a current time and an last updated time associated with a previous derived TA, a reference signal received power (RSRP), a location, Doppler information, or angle information.

Aspect 8 is the method of any of aspects 1-7, further including: receiving, from the network entity, a respective cell identifier, a respective measured reference signal ID, and a respective associated measured reference signal occasion associated with the serving cell and the candidate cell, and the TA.

Aspect 9 is the method of any of aspects 1-8, further including: receiving, from the network entity, information regarding time difference between a first measured reference signal ID associated with the serving cell and a second measured reference signal ID associated with the candidate cell for use in determining the derived TA.

Aspect 10 is the method of any of aspects 1-9, further including: receiving, from the network entity, a cell switch command indicative of switch to the candidate cell, and receiving, from the network entity, a physical downlink control channel (PDCCH) order associated with the candidate cell, where the PDCCH order is associated with a second TA.

Aspect 11 is the method of aspect 10, further including: applying the derived TA or the second TA.

Aspect 12 is the method of aspect 10, further including: applying a latest acquired TA of the derived TA or the second TA.

Aspect 13 is the method of aspect 10, where the cell switch command indicates the derived TA or the second TA, and further including: applying the derived TA or the second TA based on the cell switch command.

Aspect 14 is the method of aspect 10, where the cell switch command indicates the derived TA or the second TA, and further including: applying the second TA if the second TA is valid and apply the derived TA if there is no valid TA associated with the PDCCH order.

Aspect 15 is a method for wireless communication at a network entity, including: obtaining capability information associated a UE indicative of a support for UE-based TA update between a serving cell associated with the network entity and a candidate cell associated with the network entity for L1 or L2 mobility; transmitting, for the UE, a configuration for the UE-based TA update; and communicating, via the candidate cell, an uplink transmission or a downlink transmission based on a derived TA for the candidate cell based on a TA for the serving cell and a reception timing difference associated with the serving cell and the candidate cell.

Aspect 16 is the method of aspect 15, where the configuration is indicative of a time instance for the UE-based TA update, a downlink reference signal (DL RS) associated with the time instance, or a periodicity associated with the time instance.

Aspect 17 is the method of aspect 16, further including: transmitting, for the UE, a reference time associated with the time instance.

Aspect 18 is the method of aspect 17, where the reference time is represented by a slot starting time.

Aspect 19 is the method of aspect 18, where the reference time is associated with the periodicity, and where the periodicity is based on the capability information.

Aspect 20 is the method of any of aspects 18-19, where a time difference between the reference time and the time instance is based on the capability information.

Aspect 21 is the method of any of aspects 15-20, where a time instance for the UE-based TA update is based on an occurrence of a condition associated with the UE, where the condition is based on at least one of: a difference between a current time and an last updated time associated with a previous derived TA, a reference signal received power (RSRP), a location, Doppler information, or angle information.

Aspect 22 is the method of any of aspects 15-21, further including: transmitting, for the UE, a respective cell identifier, a respective measured reference signal ID, and a respective associated measured reference signal occasion associated with the serving cell and the candidate cell, and the TA.

Aspect 23 is the method of any of aspects 15-22, further including: transmitting, for the UE, information regarding time difference between a first measured reference signal ID associated with the serving cell and a second measured reference signal ID associated with the candidate cell for use in determining the derived TA.

Aspect 24 is the method of any of aspects 15-23, further including: transmitting, for the UE, a cell switch command indicative of switch to the candidate cell, and transmitting, for the UE, a physical downlink control channel (PDCCH) order associated with the candidate cell, where the PDCCH order is associated with a second TA.

Aspect 25 is an apparatus for wireless communication at a device including a memory and at least one processor coupled to the memory and, based at least in part on information stored in the memory, the at least one processor is configured to implement any of aspects 1 to 14.

Aspect 26 is the apparatus of aspect 25, further including a transceiver or an antenna coupled to the at least one processor.

Aspect 27 is an apparatus for wireless communication at a device including means for implementing any of aspects 1 to 14.

Aspect 28 is a computer-readable medium (e.g., a non-transitory computer-readable medium) storing computer executable code, where the code when executed by a processor causes the processor to implement any of aspects 1 to 14.

Aspect 29 is an apparatus for wireless communication at a device including a memory and at least one processor coupled to the memory and, based at least in part on information stored in the memory, the at least one processor is configured to implement any of aspects 15 to 25.

Aspect 30 is the apparatus of aspect 29, further including a transceiver or an antenna coupled to the at least one processor.

Aspect 31 is an apparatus for wireless communication at a device including means for implementing any of aspects 15 to 24.

Aspect 32 is a computer-readable medium (e.g., a non-transitory computer-readable medium) storing computer executable code, where the code when executed by a processor causes the processor to implement any of aspects 15 to 24.

1. An apparatus for wireless communication at a user equipment (UE), comprising:
a memory; and
at least one processor coupled to the memory and, based at least in part on stored information that is stored in the memory, the at least one processor is configured to cause the apparatus to:
transmit, to a network entity, capability information indicative of a support for UE-based timing advance (TA) update between a serving cell associated with the network entity and a candidate cell associated with the network entity for layer 1 (L1) or layer 2 (L2) mobility;
receive, from the network entity, a configuration for the UE-based TA update; and
communicate, with the candidate cell, an uplink transmission or a downlink transmission based on a derived TA for the candidate cell based on a TA for the serving cell and a reception timing difference associated with the serving cell and the candidate cell.

2. The apparatus of claim 1, wherein the configuration is indicative of a time instance for the UE-based TA update, a downlink reference signal (DL RS) associated with the time instance, or a periodicity associated with the time instance.

3. The apparatus of claim 2, wherein the at least one processor is further configured to cause the apparatus to:
receive, from the network entity, a reference time associated with the time instance.

4. The apparatus of claim 3, wherein the reference time is represented by a slot starting time.

5. The apparatus of claim 4, wherein the reference time is associated with the periodicity, and wherein the periodicity is based on the capability information.

6. The apparatus of claim 4, wherein a time difference between the reference time and the time instance is based on the capability information.

7. The apparatus of claim 1, wherein a time instance for the UE-based TA update is based on an occurrence of a condition associated with the UE, wherein the condition is based on at least one of: a difference between a current time and an last updated time associated with a previous derived TA, a reference signal received power (RSRP), a location, Doppler information, or angle information.

8. The apparatus of claim 1, wherein the at least one processor is further configured to cause the apparatus to:
receive, from the network entity, a respective cell identifier, a respective measured reference signal identifier (ID), and a respective associated measured reference signal occasion associated with the serving cell and the candidate cell, and the TA.

9. The apparatus of claim 1, wherein the at least one processor is further configured to cause the apparatus to:
receive, from the network entity, information regarding time difference between a first measured reference signal ID associated with the serving cell and a second measured reference signal ID associated with the candidate cell for use in determining the derived TA.

10. The apparatus of claim 1, wherein the at least one processor is further configured to cause the apparatus to:
receive, from the network entity, a cell switch command indicative of switch to the candidate cell, and
receive, from the network entity, a physical downlink control channel (PDCCH) order associated with the candidate cell, wherein the PDCCH order is associated with a second TA.

11. The apparatus of claim 10, wherein the at least one processor is further configured to cause the apparatus to:
apply the derived TA or the second TA.

12. The apparatus of claim 10, wherein the at least one processor is further configured to cause the apparatus to:
apply a latest acquired TA of the derived TA or the second TA.

13. The apparatus of claim 10, wherein the cell switch command indicates the derived TA or the second TA, and wherein the at least one processor is further configured to cause the apparatus to:
apply the derived TA or the second TA based on the cell switch command.

14. The apparatus of claim 10, wherein the cell switch command indicates the derived TA or the second TA, and wherein the at least one processor is further configured to cause the apparatus to:
apply the second TA if the second TA is valid and apply the derived TA if there is no valid TA associated with the PDCCH order.

15. An apparatus for wireless communication at a network entity, comprising:
a memory; and
at least one processor coupled to the memory and, based at least in part on stored information that is stored in the memory, the at least one processor is configured to cause the apparatus to:
obtain capability information associated a user equipment (UE) indicative of a support for UE-based timing advance (TA) update between a serving cell associated with the network entity and a candidate cell associated with the network entity for layer 1 (L1) or layer 2 (L2) mobility;
transmit, for the UE, a configuration for the UE-based TA update; and
communicate, via the candidate cell, an uplink transmission or a downlink transmission based on a derived TA for the candidate cell based on a TA for the serving cell and a reception timing difference associated with the serving cell and the candidate cell.

16. The apparatus of claim 15, wherein the configuration is indicative of a time instance for the UE-based TA update, a downlink reference signal (DL RS) associated with the time instance, or a periodicity associated with the time instance.

17. The apparatus of claim 16, wherein the at least one processor is further configured to cause the apparatus to:
transmit, for the UE, a reference time associated with the time instance.

18. The apparatus of claim 17, wherein the reference time is represented by a slot starting time.

19. The apparatus of claim 18, wherein the reference time is associated with the periodicity, and wherein the periodicity is based on the capability information.

20. The apparatus of claim 18, wherein a time difference between the reference time and the time instance is based on the capability information.

21.-30. (canceled)
